(19) United States
(12) Patent Application Publication
(10) Pub. No.: US 2008/0309578 A1
(43) Pub. Date: Dec. 18, 2008

(54) Antenna Using Proximity-Coupling Between Radiation Patch and Short-Ended Feed Line, Rfid Tag Employing the Same, and Antenna Impedance Matching Method Thereof

(75) Inventors: Hae-Won Son, Daejon (KR); Won-Kyu Choi, Daejon (KR); Gil-Young Choi, Daejon (KR); Cheol-Sig Pyo, Daejon (KR); Jong-Suk Chae, Daejon (KR)

Correspondence Address: CANTOR COLBURN, LLP, 20 Church Street, 22nd Floor, Hartford, CT, 06103, US

(73) Assignee: Electronics and Telecommunications Research Institute, Daejon (KR)

(21) Appl. No.: 12/162,069

(22) PCT Filed: Feb. 1, 2007
(86) PCT No.: PCT/KR2007/000552

§ 371 Date: Jul. 24, 2008

(30) Foreign Application Priority Data
Feb. 1, 2006 (KR) 10-2006-0009707
Dec. 19, 2006 (KR) 10-2006-0129962

(51) Int. Cl. H01Q 1/38; H01Q 1/50; G08B 13/14

(52) U.S. Cl. 343/860; 343/700 MS; 340/572.7

(57) ABSTRACT

Provided is an antenna based on proximity coupling between a short-ended microstrip feed line and a radiation patch, an RFID tag including the planar antenna, and an antenna impedance matching method thereof. The antenna includes a radiation patch configured to determine a resonant frequency of the antenna; a ground plate disposed in parallel to the radiation patch; and a feeding part disposed between the radiation patch and the ground plate and configured to provide radio frequency signals to a device connected to the antenna. The feeding part includes a feed line that is formed in a resonance length direction of the radiation patch and proximity-coupled with the radiation patch and one end of the feed line is shorted. The antenna freely controls the resistance and reactance of the antenna impedance independently and efficiently matched to a device connected to the antenna which has a predetermined impedance in wide bands.

### TECHNICAL FIELD

The present invention relates to an antenna, a radio frequency identification (RFID) tag employing the antenna, and an antenna impedance matching method thereof; and, more particularly, to a planar antenna based on proximity coupling between a short-ended microstrip feed line and a radiation patch, an RFID tag, or a transponder, which includes the planar antenna, and an antenna impedance matching method thereof.

### BACKGROUND ART

A radio frequency identification (RFID) tag is used in diverse areas, such as material management and security, along with an RFID reader, or an interrogator. In general, when an object with an RFID tag attached thereto is placed in a read zone of an RFID reader, the RFID reader modulates RFID signals having a predetermined carrier frequency to thereby produce interrogation signals and transmits the interrogation signals to the RFID tag. The RFID makes a response to the interrogation of the RFID reader.

In other words, the RFID reader modulates continuous electromagnetic waves of a predetermined frequency to thereby produce interrogation signals and transmits the interrogation signals. The RFID tag performs back-scattering modulation onto the electromagnetic waves transmitted from the RFID reader and sends them back to the RFID reader to deliver tag information stored in its internal memory. Back-scattering modulation is a method that an RFID tag transmits tag information by modulating the amplitude or phase of scattered electromagnetic waves, when the RFID tag scatters the electromagnetic waves transmitted from the RFID reader and sends them back to the RFID reader.

A passive RFID tag rectifies the electromagnetic waves transmitted from the RFID reader and uses them as its own power source. Thus, the passive RFID tag can normally operate only when the intensity of the electromagnetic waves transmitted from the RFID reader is equal to or higher than a predetermined threshold value at the position where the RFID tag is disposed. The read zone of the RFID reader depends on the intensity of the electromagnetic waves transmitted from the RFID reader and reaches the RFID tag. However, since the transmission power of an RFID reader is regulated by the U.S. Federal Communication Commission (FCC) and local regulations, there is limitation in raising the transmission power of an RFID reader. Therefore, the read zone needs to be widened without increasing the transmission power level of an RFID reader. One of the solutions to the problem is that an RFID tag efficiently receives electromagnetic waves transmitted from an RFID reader.

One of the methods for increasing the reception efficiency of an RFID tag is to use a matching circuit. Generally, an RFID tag includes a tag antenna, an RF front end, and a signal processor. The RF front end and the signal processor are formed in one chip collectively. According to the method using a matching circuit, the antenna and the RF front end are conjugate-matched through a matching circuit, which is an additional constituent element, to maximize the intensity of signals transmitted from the tag antenna to the RF front end. However, since the matching circuit composed of a capacitor and an inductor requires much space in a chip, the method using a matching circuit has a problem in the respect of miniaturization and production cost.

### DISCLOSURE

### Technical Problem

It is, therefore, an object of the present invention to provide an antenna that has wideband characteristics and can freely control the resistance and reactance of antenna impedance independently from each other by disposing a short-ended microstrip feed line that is formed in a resonance length direction of a radiation patch between the radiation patch and a ground plate and proximity-coupled with the radiation patch, and a radio frequency identification (RFID) tag employing the same.

It is another object of the present invention to provide an antenna that has impedance with a higher capacitance reactance than resistance even though the antenna is attached to a metal surface or an object having a high dielectric rate and can be matched to an RF front end in wideband efficiently, and an RFID tag employing the antenna.

It is another object of the present invention to provide a method of matching impedance of the antenna.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### Technical Solution

In accordance with one aspect of the present invention, there is provided an antenna, which includes: a radiation patch configured to determine a resonant frequency of the antenna; a ground plate disposed in parallel to the radiation patch; and a feeding part disposed between the radiation patch and the ground plate and configured to provide radio frequency (RF) signals to a device connected to the antenna. The feeding part includes: a dielectric substrate disposed in parallel between the radiation patch and the ground plate; a feed line having a shape of a microstrip line and disposed in one surface of the dielectric substrate; and a ground surface disposed toward the ground plate in parallel to the feed line with a space therebetween.

One end of the feed line is close to a central part of the radiation patch connected to the ground surface, and the other end in opposite to the shorted end has a tag chip feed for accessing to the device connected to the antenna. The ground surface of the feeding part is connected to the ground plate in direct current (DC) or in alternating current (AC) through capacitive coupling. The ground plate disposed in parallel to the radiation patch may be used as a ground surface of the feeding part.

In accordance with another aspect of the present invention, there is provided an antenna, which includes: a radiation patch configured to determine a resonant frequency of the antenna; a ground plate disposed in parallel to the radiation patch; and a feeding part disposed between the radiation patch and the ground plate in a resonance length direction of the radiation patch and proximity-coupled with the radiation patch, and configured to provide radio frequency (RF) signals to a device connected to the antenna through a feed line having an impedance lower than 100Ω in one end close to a central part of the radiation patch.

The feeding part includes: a dielectric substrate disposed in parallel between the radiation patch and the ground plate; a feed line having a shape of a microstrip line and disposed in one surface of the dielectric substrate; and a ground surface disposed toward the ground plate in parallel to the feed line with a space therebetween.

One end of the feed line close to the central part of the radiation patch is connected to a load having an impedance lower than 100Ω, and the other end in opposite to the end connected to the load has a tag chip feed for accessing to the device connected to the antenna. The load is any one between a lumped element and a distributed element.

In accordance with another aspect of the present invention, there is provided an antenna, which includes: a radiation patch configured to determine a resonant frequency of the antenna; a ground plate disposed in parallel to the radiation patch; and a feeding part disposed between the radiation patch and the ground plate and configured to provide radio frequency (RF) signals to a device connected to the antenna. The feeding part includes a feed line formed in a resonance length direction of the radiation patch and having one end proximity-coupled with the ground plate.

The feeding part includes: a dielectric substrate disposed in parallel between the radiation patch and the ground plate; a feed line having a shape of a microstrip line and disposed in one surface of the dielectric substrate; and a ground surface disposed toward the radiation patch in parallel to the feed line with a space therebetween. One end of the feed line close to a central part of the radiation patch is connected to the ground surface, and the other end in opposite to the shorted end has a tag chip feed formed therein.

In accordance with another aspect of the present invention, there is provided a Radio Frequency Identification (RFID) tag, which includes: an antenna configured to receive RF signals transmitted from an RFID reader; an RF front end configured to rectify and detect the RF signals; and a signal processor connected to the RF front end. The antenna includes: a radiation patch configured to determine a resonant frequency of the antenna; a ground plate disposed in parallel to the radiation patch; and a feeding part disposed between the radiation patch and the ground plate and configured to provide RF signals to the RF front end through a feed line which is formed in a resonance length direction of the radiation patch and proximity-coupled with the radiation patch.

The feeding part includes: a dielectric substrate disposed in parallel between the radiation patch and the ground plate; a feed line having a shape of a microstrip line and disposed in one surface of the dielectric substrate; and a ground surface disposed toward the ground plate in parallel to the feed line with a space therebetween.

One end of the feed line close to a central part of the radiation patch is connected to the ground surface, and the other end in opposite to the shorted end has a tag chip feed for accessing to the RF front end.

One end of the feed line close to the central part of the radiation patch may be connected to a load having an impedance lower than 100Ω.

In accordance with another aspect of the present invention, there is provided an impedance matching method of an antenna having a radiation patch, a ground plate disposed in parallel to the radiation patch, and a feed line disposed between the radiation patch and the ground plate in a resonance length direction of the radiation patch, comprising the steps of: a) controlling reactance of antenna input impedance by adjusting the length of the feed line; b) controlling resistance of the antenna input impedance by shifting the position of the feed line; and c) controlling reactance of the antenna input impedance by adjusting characteristic impedance of the feed line.

The reactance is controlled based on a property that the longer the feed line is, the higher the reactance of the antenna input impedance becomes in the reactance controlling step a).

The resistance is controlled based on a property that the longer the distance between the tag chip feed and the brim of the radiation patch is, the higher the resistance of the antenna input impedance in the resistance controlling step b).

### ADVANTAGEOUS EFFECTS

The technology of the present invention provides an antenna that can freely control the resistance and reactance of antenna impedance independently from each other by disposing a short-ended microstrip feed line that is formed in a resonance length direction of a radiation patch between the radiation patch and a ground plate. Also, the present invention provides a plannar antenna that has a resonance characteristic and can be matched to an antenna connection element having a predetermined impedance level efficiently in wide bands by proximity-coupling the feed line with the radiation patch, and a radio frequency identification (RFID) tag employing the antenna.

The antenna based on proximity coupling with a short-ended feed line and the RFID tag employing the antenna have resonance and wideband characteristics, and they can provide excellent performance even when they are attached to a metal surface or an object having a high dielectric rate. In addition, the present invention provides a method of matching impedance of the antenna.

### DESCRIPTION OF DRAWINGS

The above and other objects and features of the present invention will become apparent from the following description of the preferred embodiments given in conjunction with the accompanying drawings, in which:

FIG. 1 is a block diagram describing a radio frequency identification (RFID) system to which the present invention is applied;

FIG. 2 is a circuit diagram modeling a tag antenna and an RF front end;

FIG. 3 is a perspective view showing a tag antenna in accordance with a first embodiment of the present invention;

FIG. 4 is a perspective view showing a tag antenna in accordance with a second embodiment of the present invention;

FIG. 5 is a perspective view showing a tag antenna in accordance with a third embodiment of the present invention;

FIG. 6 is a perspective view showing a tag antenna in accordance with a fourth embodiment of the present invention;

FIG. 7 shows a plane view and a side view of a tag antenna to be attached to a metal object according to an embodiment of the present invention;

FIG. 8 is a smith chart showing variance of antenna input impedance according to the varying length of the feed line of the tag antenna shown in FIG. 7;

FIG. 9 is a smith chart showing antenna input impedance variance according to the distance from the brim of a radiation patch to a tag chip feed in the antenna of FIG. 7; and

FIG. 10 is a graph showing a return loss of the antenna shown in FIG. 7.

### BEST MODE FOR THE INVENTION

Other objects and aspects of the invention will become apparent from the following description of the embodiments with reference to the accompanying drawings, which is set forth hereinafter. When it is considered that detailed description on a prior art may obscure the points of the present invention, the description will not be provided. Hereinafter, specific embodiments of the present invention will be described with reference to the accompanying drawings.

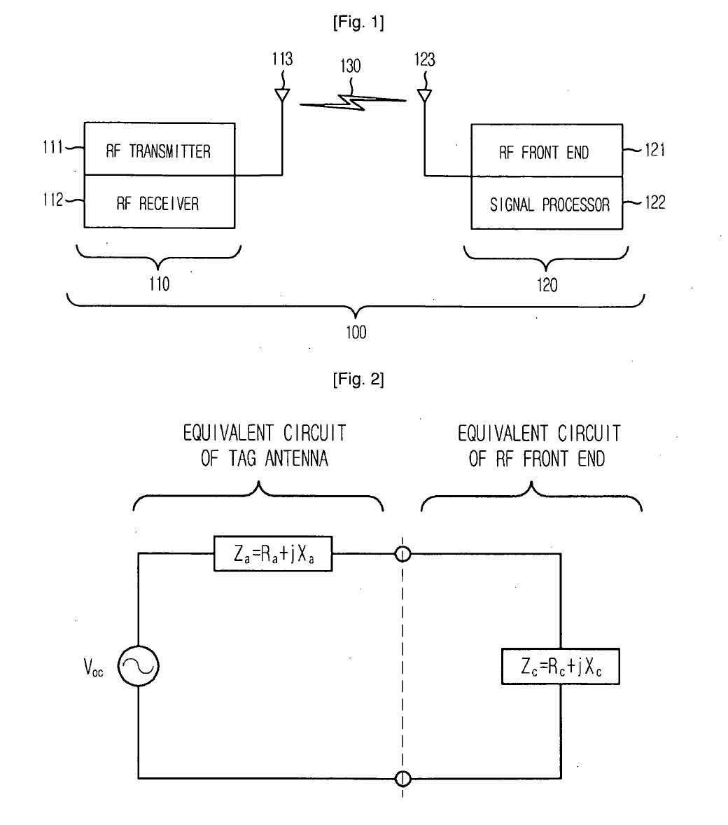

FIG. 1 is a block diagram describing a radio frequency identification (RFID) system 100 to which the present invention is applied. The RFID system 100 includes an RFID tag 120 storing unique information, an RFID reader 110 having a reading and interpreting function, and a host computer (not shown) for processing data read from the RFID tag 120 by using the RFID reader 110.

The RFID reader 110 is composed of an RF transmitter 111, an RF receiver 112, and a reader antenna 113. The reader antenna 113 is electrically connected to the RF transmitter 111 and the RF receiver 112. The RFID reader 110 transmits RF signals to the RFID tag 120 through the RFID transmitter 111 and the reader antenna 113. Also, the RFID reader receives RF signals from the RFID tag 120 through the reader antenna 113 and the RFID receiver 112. As presented in U.S. Pat. No. 4,656,463, the structure of the RFID reader 110 is widely known to those skilled in the art. Thus, detailed description on it will not be provided herein.

The RFID tag 120 includes an RF front end 121, a signal processor 122 and a tag antenna 123. In case of a passive RFID tag, the RF front end 121 supplies power for the operation of the signal processor 122 by converting the received RF signals into direct current (DC) voltage. Also, the RF front end 121 extracts baseband signals from the received RF signals. Since the structure of the RF front end 121 is widely known to those skilled in the art of the present invention, as shown in U.S. Pat. No. 6,028,564, detailed description on the structure will not be provided herein. The signal processor 122, too, may have a structure known to those skilled in the art of the present invention, and an example of it is presented in U.S. Pat. No. 5,942,987.

Herein, the operation of the RFID system 100 will be described. The RFID reader 110 modulates RF signals having a predetermined carrier frequency and transmits an interrogation to the RFID tag 120. The RF signals generated in the RFID transmitter 111 of the RFID reader 110 are transmitted outside in the form of electromagnetic waves through the reader antenna 113. The electromagnetic waves 130 transmitted outside are delivered to the tag antenna 123, which delivers the received electromagnetic waves 130 to the RF front end 121. When the amplitude of the RF signals received in the RF front end 121 is higher than a minimally required level of power for operating the RFID tag 120, the RFID tag 120 performs back-scattering modulation onto the electromagnetic waves 130 transmitted from the RFID reader 110 and responds to the interrogation of the RFID reader 110.

Herein, to widen the read zone of the RFID reader 110, the amplitude of the electromagnetic waves 130 transmitted out of the RFID reader 110 should be high enough to supply operation power required by the RFID tag 120. Also, the electromagnetic waves 130 transmitted out of the RFID reader 110 should be delivered to the RF front end 121 with almost no loss by using a highly efficient tag antenna 123. After all, the tag antenna 123 should have a resonance characteristic in the carrier frequency of the RFID reader 110 and achieve conjugate matching with the RF front end 121 to have a high efficiency.

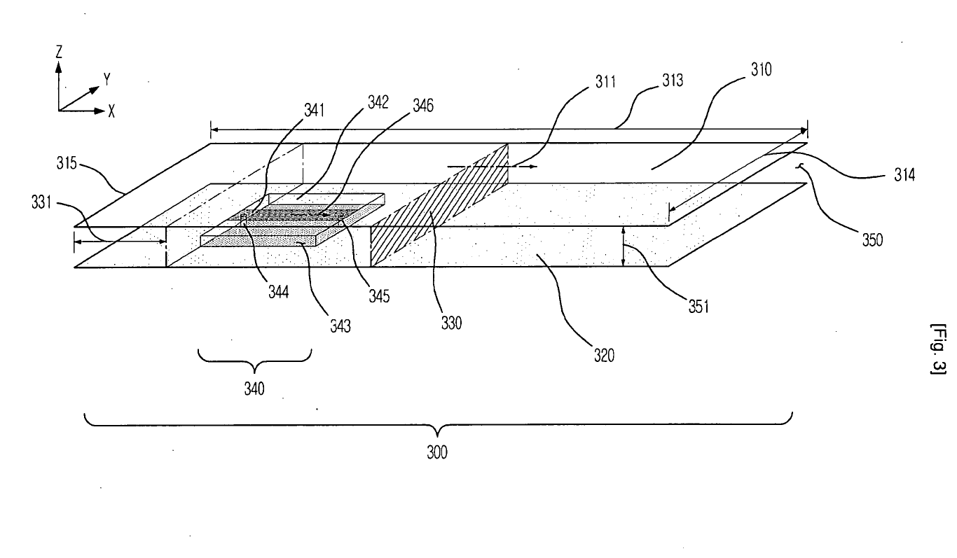

FIG. 2 is an equivalent circuit diagram modeling the tag antenna 123 and the RF front end 121. The equivalent circuit is composed of a voltage source V_{oc}, an antenna impedance Zₐ, and an RF front end impedance Z_{c}.

The voltage source V_{oc} and the antenna impedance Zₐ form an equivalent circuit of the tag antenna 123, whereas the RF front end impedance Z_{c} forms an equivalent circuit of the RF front end 121. The antenna impedance Zₐ is composed of a real part Rₐ and an imaginary part Xₐ. The real part Rₐ denotes an equivalent resistance of the tag antenna 123, and the imaginary part Xₐ denotes an equivalent reactance of the tag antenna 123. RF front end impedance is composed of a real part R_{c} and an imaginary part X_{c}, too. The real part R_{c} denotes an equivalent resistance of the RF front end 121, and the imaginary part X_{c} denotes an equivalent reactance of the RF front end 121.

Generally, when the antenna impedance Zₐ and RF front end impedance Z_{c} are conjugate-matched, the maximum power is delivered from the tag antenna 123 to the RF front end 121. Conjugate matching is to make the two complex impedances have the same absolute values but their phases have different signs from each other. In short, when the impedance of the tag antenna 123 or the impedance of the RF front end 121 are controlled to be ‘Rₐ=R_{c}’ and ‘Xₐ=−X_{c}’, respectively, the maximum power is delivered from the tag antenna 123 to the RF front end 121.

Generally, the RF front end 121 of a passive RFID tag or a semi-passive RFID tag is composed of a rectifying and detection circuit using a diode, and it does not include a rectifying circuit for reducing the area of a chip. Thus, the RF front end 121 has complex impedances which is different from a general impedance, i.e., 50Ω, and has a low resistance R_{c} and a high capacitive reactance X_{c}. The antenna impedance Zₐ for conjugate matching should have low resistance Rₐ and high inductive reactance Xₐ and, at the same time, it should resonate to the frequency of electromagnetic waves transmitted out of the RFID reader 110.

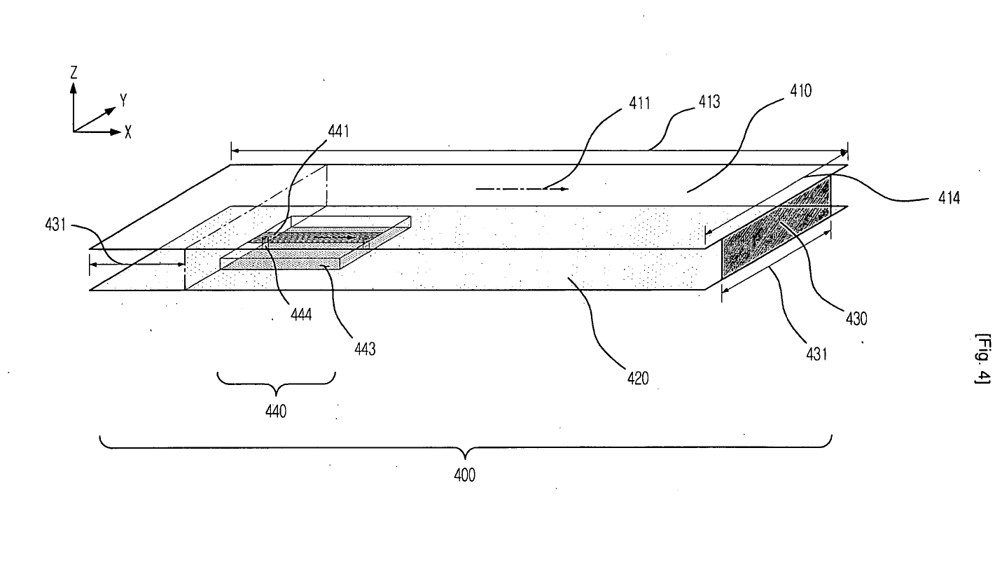

FIG. 3 is a perspective view showing a tag antenna in accordance with a first embodiment of the present invention. The tag antenna 300 includes a rectangular radiation patch 310 and a ground plate 320 disposed in parallel to the radiation patch 310. The radiation patch 310 is proximity-coupled with a microstrip feed line 341.

The feeding part 340 of the tag antenna 300 includes a dielectric substrate 342 disposed between the radiation patch 310 and the ground plate 320, the microstrip feed line 341 disposed in one side of the dielectric substrate 342, and the ground surface 343 disposed in the other side of the dielectric substrate 342. The feeding part 340 is interposed between the radiation patch 310 and the ground plate 320, and the ground surface 343 of the feeding part 340 is connected to the ground plate 320 in direct current (DC) or in alternating current (AC) through capacitive coupling. The ground surface 343 connected to the ground plate 320 in alternating current can be fabricated by attaching both-sided tape onto the ground plate 320. Also, the ground plate 320 can be shared as the ground surface 343 of the feeding part 340. In this case, one metal plate is simultaneously used as the ground plate 320 and the ground surface 343.

The feed line 341 of the feeding part 340 is formed in a resonance length direction 311 of the radiation patch 310. One end of the feed line 341 is connected to the ground surface 343, while the other end has a tag chip feed 344 connected to the RF front end 121 formed therein. A shorting part 345 of the feed line 341 is disposed in the central part 330 of the radiation patch 310, and the tag chip feed 344 is disposed at the brim 315 of the radiation patch 310.

The resonant frequency of the tag antenna 300 is mainly determined based on the length 313 of the radiation patch 310. The radiation patch 310 and the ground plate 320 are disposed in parallel to each other with a predetermined space 351 between them, and the entire or part of the space between them is filled with a predetermined dielectric substance 350 including air.

The reactance Xₐ of the antenna impedance Zₐ is mainly determined based on the characteristic impedance Z_{c} of the feed line 341 and the entire length lₜ of the feed line 341 from the tag chip feed 344 to the shorting part 345. The longer the length lₜ of the feed line 341 is, the higher reactance Xₐ of the antenna impedance Zₐ becomes.

When the tag antenna 300 resonates, the resistance Rₐ of the antenna impedance Zₐ is mainly determined based on the distance 331 from the brim 315 of the radiation patch 310 to the tag chip feed 344. When the distance 331 is zero, the resistance Rₐ of the antenna impedance Zₐ becomes 0Ω. The longer the distance 331 is, the higher the resistance Rₐ of the antenna impedance Zₐ becomes. The increase rate of the resistance Rₐ of the antenna impedance Zₐ based on the increase of the distance 331 is different according to the characteristics impedance Z_{c} of the feed line 341 and the size of the coupling capacitance between the feed line 341 and the radiation patch 310.

The tag antenna 300 of the present invention to the impedance Z_{c} of the RF front end 121 is conjugate-matched through the following steps.

In the first step, the distance 331 from the brim 315 of the radiation patch 310 to the tag chip feed 344 is set at zero.

In the second step, the characteristics impedance Zₒ of the feed line 341 and the entire length lₜ of the feed line 341 from the tag chip feed 344 to the shorting part 345 are adjusted to satisfy ‘Xₐ=−X_{c}’.

In the third step, the distance 331 from the brim 315 of the radiation patch 310 to the tag chip feed 344 is adjusted by transferring the position of the feeding part 340 including the feed line 341 toward the center 330 of the radiation patch 310.

In the fourth step, the antenna impedance Zₐ is delicately adjusted by repeating the second and third steps.

As described above, the antenna 300 of the present invention controls the reactance Xₐ of the antenna impedance Zₐ by adjusting the characteristics impedance Zₒ of the feed line 341 and the entire length lₜ of the feed line 341 from the tag chip feed 344 to the shorting part 345. It also controls the resistance Rₐ of the antenna impedance Zₐ. In short, since the antenna 300 of the present invention can freely control the reactance Xₐ and the resistance Rₐ of the antenna impedance Zₐ, it can be efficiently matched with the RF front end 121 having a predetermined impedance level. Particularly, since it is easy to fabricate an antenna having as low resistance Rₐ as several ohms (Ω) by adjusting the distance 331 from the brim 315 of the radiation patch 310 to the tag chip feed 344, the antenna can be efficiently matched to the RF front end 121 having a low resistance and high capacitive reactance. Meanwhile, the antenna 300 of the present invention has a wideband characteristic, just as conventional antennas using proximity-coupling feed.

According to the conventional proximity-coupling method, one end of a feed line disposed close to the center of a radiation patch and the other end is stretched out of the radiation patch and has a tag chip feed formed therein. An example of the conventional proximity-coupling method is disclosed in an article by D. M. Pozar entitled “Increasing the bandwidth of a microstrip antenna by proximity coupling,” Electronics Letters, Vol. 23, No. 8, April 1987.

The tag antenna 300 suggested in the present invention has the feed line 341, one end of which close to the center 330 of the radiation patch 310 is shorted. However, when the end of which close to the center 330 of the radiation patch 310 is not shorted and a distributed element or a lumped element having a predetermined impedance is connected, the basic concept of the present invention can be applied if the element impedance is sufficiently low, specifically, lower than 100Ω. Also, the end 345 of the feed line 341 close to the center of the radiation patch 310 has an inductive impedance lower than 100Ω, there is an effect that the length of the feed line 341 can be reduced. Herein, it should be considered in controlling the antenna impedance Zₐ that the antenna impedance Zₐ is partly affected by the impedance of an element connected to the end 345 of the feed line 341.

Referring to FIG. 3, the length 313 of the radiation patch 310 is determined such that the radiation patch 310 has a resonance characteristic in the antenna operation frequency. However, the length 313 of the radiation patch 310 can be reduced by almost a half while maintaining the resonant frequency if a shorting plate or a series of shorting pins are set up between the radiation patch 310 and the ground plate 320.

FIG. 4 is a perspective view showing a tag antenna in accordance with a second embodiment of the present invention. The tag antenna 400 of FIG. 4 reduces the length 413 of the radiation patch 410 by additionally including the shorting plate 430 between the radiation patch 410 and the ground plate 42 to connect the radiation patch 410 and the ground plate 420 with each other. The shorting plate 430 is set up perpendicularly to a resonance length direction 41 at the brim in opposite to the tag chip feed 444 in the radiation patch 410. The width 431 of the shorting plate 430 may be different from the width 414 of the radiation patch 410. In FIG. 4, the input impedance of the tag antenna 400 is controlled in the same method as in FIG. 3.

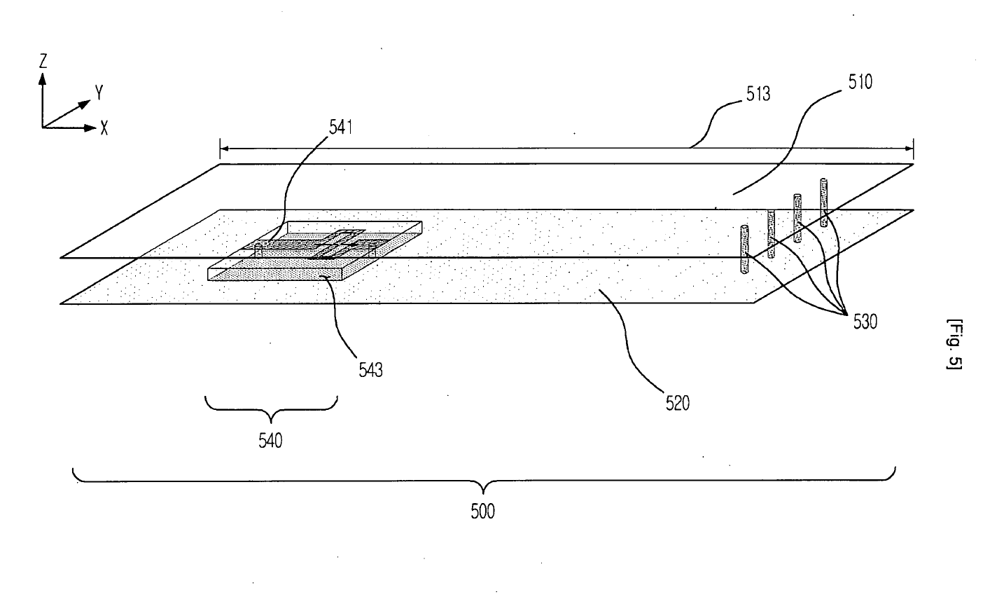

FIG. 5 is a perspective view showing a tag antenna in accordance with a third embodiment of the present invention. The tag antenna 500 reduces the length 513 of the radiation patch 510 by additionally disposing shorting pins 530 between the radiation patch 510 and the ground plate 520 to connect the radiation patch 510 with the ground plate 520. The shorting pins 530 are set up perpendicularly to the resonance length direction at the brim in opposite to the tag chip feed in the radiation patch 510. The input impedance of the tag antenna 500 shown in FIG. 5 is controlled in the same method as in FIG. 3.

Also, the tag antenna 500 of FIG. 5 has a small feeding part 540 by forming the feed line 541 in a meander structure. The feed lines 341 and 441 of the tag antennas 300 and 400 illustrated in FIGS. 3 and 4 have a straight line shape. However, the feed lines 341 and 441 may be fabricated in diverse structures widely known to those skilled in the art of the present invention, which includes the meander structure, to reduce the size of the feeding parts 340 and 440.

To shorten the length of the tag antennas 300, 400 and 500 illustrated in FIGS. 3 to 5, slots may be formed in the radiation patches 310, 410 and 510. Besides, other methods widely known to those skilled in the art to which the present invention pertains may be used such as increasing the specific dielectric rate of the dielectric substance filling the space between the radiation patches 310, 410 and 510 and the ground plates 320, 429 and 520.

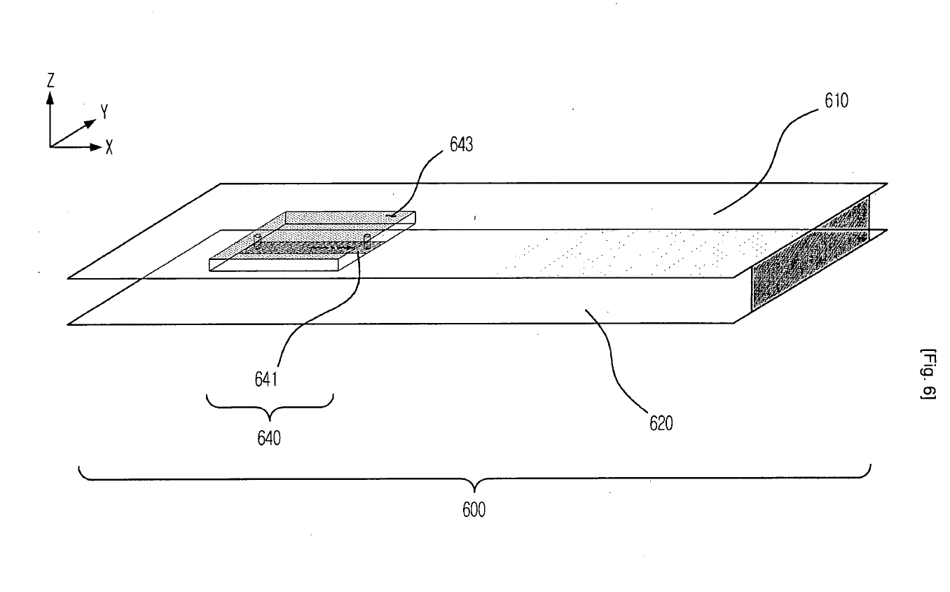

FIG. 6 is a perspective view showing a tag antenna 600 in accordance with a fourth embodiment of the present invention. In the tag antenna 600 shown in FIG. 6, a ground plate 643 of a feeding part 640 may be connected to a radiation patch 610 in direct current or in alternating current through capacitive coupling. The tag antenna 600 has its ground plate 620 proximity-coupled with the feed line 641. The tag antenna 600 operates the same and has the same effects as the tag antennas 300, 400 and 500 shown in FIGS. 3 to 5 where the ground surfaces 343, 443 and 543 of the feeding parts 340, 440 and 540 are connected to the ground plates 320, 420 and 520 in direct current, or in alternating current through capacitive coupling.

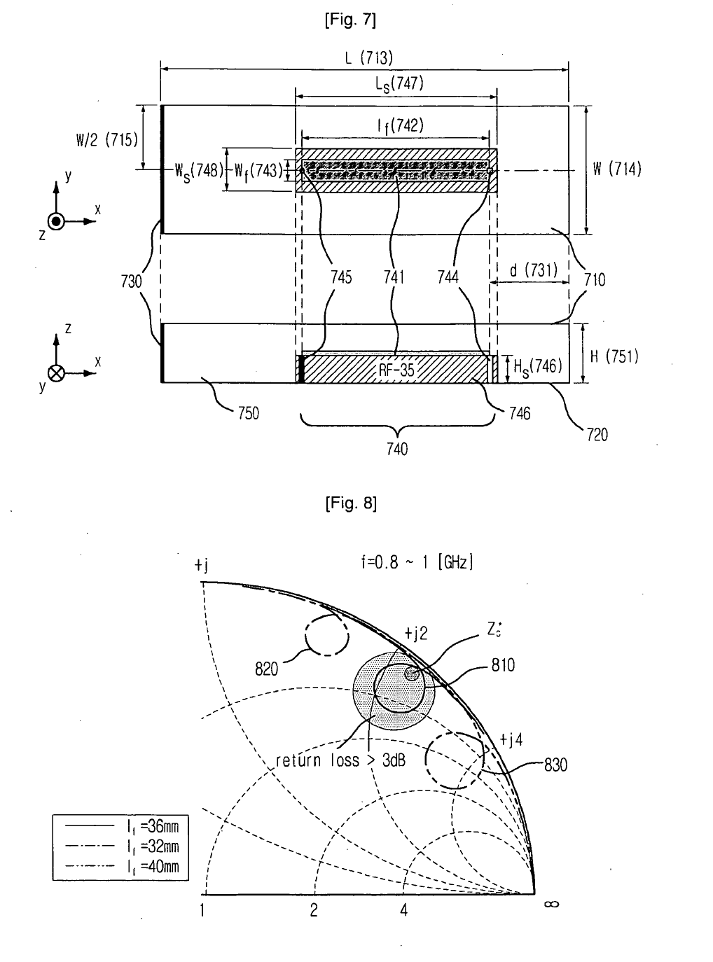

FIG. 7 shows a plane view and a side view of a tag antenna to be attached to a metal object according to an embodiment of the present invention. The tag antenna fabricated to be attached to a metal object is conjugate-matched to a tag chip impedance Z_{c} of ‘7.4-j111[Ω]’ in an RF front end 121. The tag antenna to be attached to a metal object shares a ground plate 720 as a ground surface of a feeding part 740, and it includes a shorting plate 730 set up in the same width as the width of the radiation patch 710 between the radiation patch 710 and the ground plate 720 to shorten the length L 713 of the radiation patch 710. One end of the feed line 741 close to the shorting plate 730 in the tag antenna 700 is connected to the ground plate 720 by shorting pins 745. The other end of the feed line 741 disposed at the open brim of the radiation patch 710 has a tag chip feed 744 formed therein. The tag chip feed 744 is used to access to the RF front end 121. Also, a dielectric substance 746 forming the feeding part 740 of the tag antenna 700 may be an RF-35 substrate (er=3.5 and tan δ=0.0018), and foam 750 (er=1.1 and tan δ=0.001) for supporting the shape of the antennas is filled between the radiation patch 710 and the ground plate 720.

Performing the impedance controlling process described with reference to FIG. 4, the tag antenna 700 is fabricated in the following specification. The resonance direction length L 713 of the radiation patch 710 is 73 mm, and the width W 714 of the radiation patch 710 is 25 mm. The distance H 751 between the radiation patch 710 and the ground plate 720 is 3 mm. The length Lₛ 747 of the dielectric substrate 746 is 40 mm. The width Wₛ 748 and thickness Hₛ 746 of the dielectric substrate 746 are 7 mm and 1 mm, respectively. The length lₜ 742 and the width Wₜ of the feed line 741 are 36 mm and 3 mm, respectively. The distance d 731 from the brim of the radiation patch 710 to the tag chip feed 744 formed in the feed line 741 is 8 mm.

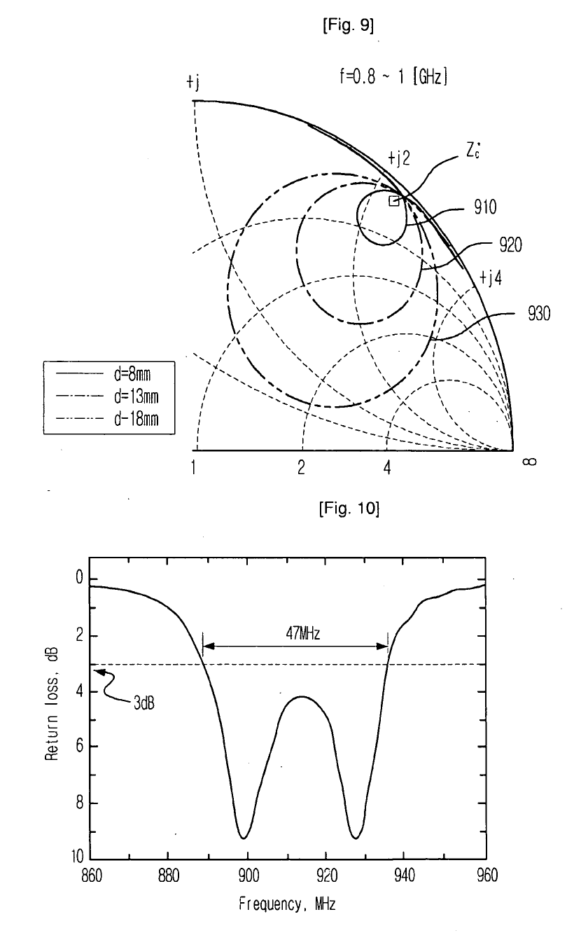

As shown in the smith charts of FIGS. 8 and 9 that present variance 810 or 910 of the antenna input impedance Zₐ according to the varying frequency, the antenna input impedance Zₐ has an α shape surrounding the complex conjugate value Z_{c}* of the tag chip input impedance Z_{c}. The wideband characteristics of the tag antenna come from the shape.

FIG. 8 is a smith chart showing variance of antenna input impedance Zₐ according to the varying length lₜ 742 of the feed line 741 of the tag antenna shown in FIG. 7.

As illustrated in FIG. 8, as the length lₜ of the feed line 741 becomes long, the size of the imaginary part Xₐ of the antenna input impedance Zₐ increases. When the length lₜ of the feed line 741 becomes short, the size of the imaginary part Xₐ of the antenna input impedance Zₐ decreases.

FIG. 9 is a diagram showing variance of the antenna input impedance Zₐ according to the varying distance d 731 from the brim of the radiation patch 710 to a tag chip feed 744 when the tag antenna of FIG. 7 is attached to a metal object of an infinite size.

As illustrated in FIG. 9, when the distance d from the brim of the radiation patch 710 to the tag chip feed 744 of the feed line 741 increases, the diameter of the α-shaped orbital trace of the antenna input impedance Zₐ increases. Therefore, when the distance d from the brim of the radiation patch 710 to the tag chip feed 744 of the feed line 741 increases, the size of the real part R of the antenna input impedance Zₐ increases in the tag antenna of the present invention. When the distance d from the brim of the radiation patch 710 to the tag chip feed 744 of the feed line 741 decreases, the size of the real part R of the antenna input impedance Zₐ increases.

As described above, the tag antenna of the present invention can independently control the imaginary part Xₐ and the real part R of the antenna input impedance Zₐ by controlling the length lₜ of the feed line and the distance d from the brim of the radiation patch 710 to the tag chip feed 744. However, since change in the length lₜ of the feed line and the distance d from the brim of the radiation patch 710 to the tag chip feed 744 partly affects the resonant frequency of the tag antenna, the length L of the radiation patch 710 needs t be controlled delicately.

FIG. 10 is a graph showing a return loss of the antenna shown in FIG. 7. The tag antenna shows wideband characteristics of 47 MHz around the resonant frequency, which is 915 MHz, when the return loss is 3 dB. Therefore, the tag antenna of the present invention can efficiently perform wideband matching to the RF front end having a predetermined impedance.

The present application contains subject matter related to Korean patent application Nos. 2006-0009707 and 2006-0129962, filed in the Korean Intellectual Property Office on Feb. 1, 2006, and Dec. 19, 2006, respectively, the entire contents of which is incorporated herein by reference.

While the present invention has been described with respect to certain preferred embodiments, it will be apparent to those skilled in the art that various changes and modifications may be made without departing from the scope of the invention as defined in the following claims.

1. An antenna, comprising:
a radiation patch configured to determine a resonant frequency of the antenna;
a ground plate disposed in parallel to the radiation patch; and
a feeding part disposed between the radiation patch and the ground plate and configured to provide radio frequency (RF) signals to a device connected to the antenna,
wherein the feeding part includes a feed line that is formed in a resonance length direction of the radiation patch and proximity-coupled with the radiation patch and one end of the feed line is shorted.

2. The antenna as recited in claim 1, wherein the feeding part includes:
a dielectric substrate disposed in parallel between the radiation patch and the ground plate;
a feed line having a shape of a microstrip line and disposed in one surface of the dielectric substrate; and
a ground surface disposed toward the ground plate in parallel to the feed line with a space therebetween.

3. The antenna as recited in claim 2, wherein one end of the feed line is close to a central part of the radiation patch connected to the ground surface, and the other end in opposite to the shorted end has a tag chip feed for accessing to the device connected to the antenna.

4. The antenna as recited in claim 2, wherein the ground surface of the feeding part is connected to the ground plate in direct current (DC).

5. The antenna as recited in claim 2, wherein the ground surface of the feeding part is connected to the ground plate through capacitive coupling in alternating current (AC).

6. The antenna as recited in claim 2, wherein the ground plate is used as the ground surface of the feeding part.

7. The antenna as recited in claim 1, further comprising a shorting means for connecting the radiation patch to the ground plate.

8. The antenna as recited in claim 7, wherein the shorting means is a shorting plate or shorting pins.

9. The antenna as recited in claim 1, wherein the feed line has a meander structure.

10. The antenna as recited in claim 1, wherein the radiation patch has a slot formed therein.

11. The antenna as recited in claim 1, wherein an imaginary part of an antenna input impedance changes according to the length of the feed line.

12. The antenna as recited in claim 1, wherein an imaginary part of the antenna input impedance changes according to characteristic impedance of the feed line.

13. The antenna as recited in claim 1, wherein a real part of the antenna input impedance changes according to the position of the feed line.

14. An antenna, comprising:
a radiation patch configured to determine a resonant frequency of the antenna;
a ground plate disposed in parallel to the radiation patch; and
a feeding part disposed between the radiation patch and the ground plate and configured to provide radio frequency (RF) signals to a device connected to the antenna,
wherein the feeding part is formed in a resonance length direction of the radiation patch, proximity-coupled with the radiation patch, and includes a feed line having an impedance lower than 100Ω in one end close to a central part of the radiation patch.

15. The antenna as recited in claim 14, wherein the feeding part includes:
a dielectric substrate disposed in parallel between the radiation patch and the ground plate;
a feed line having a shape of a microstrip line and disposed in one surface of the dielectric substrate; and
a ground surface disposed toward the ground plate in parallel to the feed line with a space therebetween.

16. The antenna as recited in claim 15, wherein one end of the feed line close to the central part of the radiation patch is connected to a load having an impedance lower than 100Ω, and the other end in opposite to the end connected to the load has a tag chip feed for accessing to the device connected to the antenna.

17. The antenna as recited in claim 16, wherein the load is any one between a lumped element and a distributed element.

18. The antenna as recited in claim 15, wherein the ground surface of the feeding part is connected to the ground plate in direct current.

19. The antenna as recited in claim 15, wherein the ground surface of the feeding part is connected to the ground plate in alternating current through capacitive coupling.

20. The antenna as recited in claim 15, wherein the ground plate is used as the ground surface of the feeding part.

21. The antenna as recited in claim 14, wherein the imaginary part of the antenna input impedance is changed according to characteristic impedance of the feed line and the length of the feed line.

22. The antenna as recited in claim 14, wherein the real part of the antenna input impedance is changed according to the position of the feed line.

23. An antenna, comprising:
a radiation patch configured to determine a resonant frequency of the antenna;
a ground plate disposed in parallel to the radiation patch; and
a feeding part disposed between the radiation patch and the ground plate and configured to provide radio frequency (RF) signals to a device connected to the antenna,
wherein the feeding part includes a feed line formed in a resonance length direction of the radiation patch and having one end proximity-coupled with the ground plate.

24. The antenna as recited in claim 23, wherein the feeding part includes:
a dielectric substrate disposed in parallel between the radiation patch and the ground plate;
a feed line having a shape of a microstrip line and disposed in one surface of the dielectric substrate; and
a ground surface disposed toward the radiation patch in parallel to the feed line with a space therebetween.

25. The antenna as recited in claim 24, wherein one end of the feed line close to a central part of the radiation patch is connected to the ground surface, and the other end in opposite to the shorted end has a tag chip feed for accessing to the device connected to the antenna.

26. The antenna as recited in claim 24, wherein the ground surface of the feeding part is connected to the radiation patch in direct current.

27. The antenna as recited in claim 24, wherein the ground surface of the feeding part is connected to the radiation patch in alternating current through capacitive coupling.

28. The antenna as recited in claim 24, wherein the radiation patch is used as the ground surface of the feeding part.

29. The antenna as recited in claim 23, wherein the imaginary part of the antenna input impedance is changed according to the characteristic impedance of the feed line and the length of the feed line.

30. The antenna as recited in claim 23, wherein the real part of the antenna input impedance is changed according to the position of the feed line.

31. A Radio Frequency Identification (RFID) tag, comprising:
an antenna configured to receive RF signals transmitted from an RFID reader;
an RF front end configured to rectify and detect the RF signals; and
a signal processor connected to the RF front end,
wherein the antenna includes:
a radiation patch configured to determine a resonant frequency of the antenna;
a ground plate disposed in parallel to the radiation patch; and
a feeding part disposed between the radiation patch and the ground plate and configured to provide RF signals to the RF front end through a feed line which is formed in a resonance length direction of the radiation patch and proximity-coupled with the radiation patch.

32. The RFID tag as recited in claim 31, wherein the feeding part includes:
a dielectric substrate disposed in parallel between the radiation patch and the ground plate;
a feed line having a shape of a microstrip line and disposed in one surface of the dielectric substrate; and
a ground surface disposed toward the ground plate in parallel to the feed line with a space therebetween.

33. The RFID tag as recited in claim 32, wherein one end of the feed line close to a central part of the radiation patch is connected to the ground surface, and the other end in opposite to the shorted end has a tag chip feed for accessing to the RF front end.

34. The RFID tag as recited in claim 32, wherein one end of the feed line close to the central part of the radiation patch is connected to a load having an impedance lower than 100Ω, and the other end in opposite to the end connected to the load has a tag chip feed for accessing to the RF front end.

35. The RFID tag as recited in claim 34, wherein the load is any one between a lumped element and a distributed element.

36. The RFID tag as recited in claim 32, wherein the ground surface of the feeding part is connected to the ground plate in direct current.

37. The RFID tag as recited in claim 32, wherein the ground surface of the feeding part is connected to the ground plate in alternating current through capacitive coupling.

38. The RFID tag as recited in claim 32, wherein the ground plate is used as the ground surface of the feeding part.

39. The RFID tag as recited in claim 31, wherein the imaginary part of the antenna input impedance is changed according to characteristic impedance of the feed line and the length of the feed line.

40. The RFID tag as recited in claim 32, wherein the real part of the antenna input impedance is changed according to the position of the feed line.

41. An impedance matching method of an antenna having a radiation patch, a ground plate disposed in parallel to the radiation patch, and a feed line disposed between the radiation patch and the ground plate in a resonance length direction of the radiation patch, comprising the steps of:
a) controlling reactance of antenna input impedance by adjusting the length of the feed line; and
b) controlling resistance of the antenna input impedance by shifting the position of the feed line.

42. The impedance matching method as recited in claim 41, further comprising the step of:
c) controlling reactance of the antenna input impedance by adjusting characteristic impedance of the feed line.

43. The impedance matching method as recited in claim 41, wherein the reactance is controlled based on a property that the longer the feed line is, the higher the reactance of the antenna input impedance becomes in the reactance controlling step a).

44. The impedance matching method as recited in claim 41, wherein the resistance of the antenna input impedance is controlled by adjusting the distance from a tag chip feed formed at one end of the feed line close to the brim of the radiation patch to the brim of the radiation patch in the resistance controlling step b).

45. The impedance matching method as recited in claim 44, wherein the resistance is controlled based on a property that the longer the distance between the tag chip feed and the brim of the radiation patch is, the higher the resistance of the antenna input impedance in the resistance controlling step b).
